(19) United States
(12) Patent Application Publication
(10) Pub. No.: US 2011/0067822 A1
(43) Pub. Date: Mar. 24, 2011

(54) SYSTEM AND METHOD FOR ENHANCING THE SAFETY OF ELECTRICALLY OPERATED FOLDING PARTITIONS

(75) Inventors: Stephen F. Cole, Great River, NY (US); Kathleen Cole, Great River, NY (US)

(73) Assignee: Gym Door Repairs, Inc., Huntington Station, NY (US)

(21) Appl. No.: 12/868,002

(22) Filed: Aug. 25, 2010

Related U.S. Application Data
(60) Provisional application No. 61/236,660, filed on Aug. 25, 2009.

(51) Int. Cl. E06B 9/00; E06B 9/80

(52) U.S. Cl. 160/127; 160/405

(57) ABSTRACT

A system and method for enhancing the safety of an electrically operated folding partition. A control panel is used to control movement of a moveable portion of the folding partition. The control panel may include an authentication device in the form of a biometric reader. The control panel may also include an RF-ID reader effective to emit an electromagnetic wave. When a tag is in a vicinity of the wave, the reader can detect the presence of the tag and inhibit movement of the moveable portion. The tag may be placed on an object used by a disabled individual such as on a wheelchair.

### PRIORITY

This application claims priority to U.S. Provisional Application No. 61/236,660 filed Aug. 25, 2009, which is hereby incorporated by reference in its entirety.

### BACKGROUND OF THE INVENTION

1. Field of the Invention

The present disclosure generally relates to electrically operated folding partitions, and more particularly to an electrically operated folding partition system which includes a device effective to verify the identity of a user thereof using biometric authentication and to ensure disabled individuals are not in the vicinity of the partition before the folding partition becomes operable.

2. Description of the Related Art

Portable folding partitions or walls having a plurality of vertically oriented units have conventionally been used to provide temporary walls to, for example, divide off two or more areas of a given room. In particular, folding portable partitions provide a quick and efficient means to divide large open rooms, such as a school gymnasium or auditorium, into smaller areas. The vertically oriented units are suspended from a horizontal rail system along which the units are movable. In order to facilitate movement of the portable folding partitions, casters or wheels may be provided, which allow the portable partition to be easily positioned to the desired location, and then rolled back into its storage area for later use.

Portable folding partitions have been adapted to include mechanisms which open and close the moving partitions automatically by an electrical system. However, due to the large amount of force needed to move the weight of the folding partitions, electrically operated folding partitions can cause injury, or even death, to a person who accidentally becomes trapped between the partitions. Accordingly, electrically operated folding operable partitions should only be operated by an individual who is adequately trained and qualified to do so.

In order to prevent accidents caused by electrically operated folding partitions, some electrically operated folding partitions have been adapted to include a key which an operator is required to turn, while simultaneously holding a switch, to open or close the folding partition. In theory, these types of electrically operated folding partitions provide an added layer of security over conventional electrically operated folding partitions, because some able individual would presumably be watching the partition the entire time it is opening or closing, and hence would stop the folding partition if an object, such as a person, entered the path of the folding partition.

However, this type of electrically operated folding partition can easily be overridden, by, for example, wedging an object in the switch to hold it down, thus allowing the electrically operated folding partition to operate unsupervised. Moreover, the keys used in this type of electrically operated folding partition may be stolen, therefore allowing the electrically operated folding partitions to be operated by unauthorized, untrained users. Furthermore, a careless operator who wishes to attend to other matters, may provide the key to an individual who is neither trained nor authorized, thus allowing the unauthorized, untrained individual to operate the electrically operated folding partition.

Accordingly, in order to make electrically operated folding partitions more safe, many states have enacted laws requiring schools to install a safety device that will (a) stop the forward motion of an electrically operated folding partition whenever a person passes between the moving partition and the wall, and (b) stop the partition when a person is present in an area where the partition is being stacked. One such example of this type of electrically operated folding partition is described in U.S. Pat. No. 5,244,030 to Cole et al., the contents of which are hereby incorporated by reference. In particular, the electrically operated folding partition described in U.S. Pat. No. 5,244,030 to Cole et al. includes a mechanism for shutting down the electrical operation circuit of the folding operable walls when a physical obstruction interrupts an infrared barrier curtain on opposite sides of an operating path of the folding operable walls.

However, even with electrically operated folding partitions containing automatic reversal sensors or automatic shut-off sensors, there is danger that an undetected individual will become trapped between the folding partitions. Accordingly, many states have enacted laws requiring schools to equip electrically operated folding partitions with two key-operated, tamper-proof, constant pressure control stations that are wired in series, and are remotely located at opposite ends. These requirements ensure that electrically operated folding partitions are designed and constructed so as to require simultaneous activation of both control stations to operate the folding partition. In theory, requiring an operator to be present at each end of the electrically operated folding partition the entire time the electrically operated folding partitions is being operated ensures that someone will be supervising each end of the electrically operated folding partition, and hence will be able to stop the electrically operated folding operable partition should an object, such as a person, enter the path of the folding partition.

However, these types of systems may be overridden in much the same manner as the electrically operated folding partitions described above, which may be operated with key and switch. Moreover, even with two-key operated electrically operated folding partitions, an authorized operator, such as a school gym teacher or school custodian, may ask someone who is not authorized to operate the electrically operated folding partition for assistance in operating the same, therefore severely compromising the safety of the folding partition. Indeed, conventional electrically operated folding partitions do not provide any means to validate if an operator is authorized to operate the electrically operated folding partition, other than a key, which as discussed above, can easily be compromised.

In general, an individual's identity may be validated by possession-based information, such as a fingerprint or identification card, or by knowledge-based information, such as a password or personal identification number. Many systems used to validate the identity of individuals require an individual to input multiple types of possession-based information, multiple types of knowledge-based information, or combinations of possession-based information and knowledge-based information, in order to enhance security.

Biometrics is the science and technology of measuring and analyzing biological data. Biometric verification is any means by which an individual can be uniquely identified by evaluating one or more distinguishing biological traits. Unique identifiers include fingerprints, facial geometry, hand geometry, earlobe geometry, retina and iris patterns, voice waves, signatures, and keystroke dynamics. In general, biometric verification systems record a person's unique biological traits, which are kept in a database during an enrollment phase. When identification verification is subsequently required, a new record is captured and compared with the records in the database stored in the test phase to estimate the distance between the new record and the stored templates using an algorithm. If the data in the new record matches that in the database record, the person's identity is confirmed.

Biometric authentications systems can be more convenient for the users since there is no password to be forgotten or key to be lost. Biometric characteristics can be divided into physiological biometrics and behavioral biometrics. Physiological biometrics are related to characteristics of one's anatomy, such as fingerprints and hand geometry. Behavior biometrics, on the other hand, are related to an individual's behavior, such as signature verification or keystroke dynamics.

Fingerprint authentication or verification is a physiological biometric which involves verifying a match between two fingerprints, and requires the comparison of several features of the fingerprint pattern. These include patterns which are aggregate characteristics of ridges and minutia points, characteristics found within the fingerprint patterns. The three basic patterns of fingerprint ridges are the arch, loop, and whorl. Minutiae and patterns are very important in the analysis of fingerprints since no two fingerprints have been shown to be identical, even in the case of identical twins. Moreover, because one's fingerprints typically do not change over the lifetime of an individual, fingerprints are a reliable way to identify an individual.

Fingerprint recognition systems have sensors that capture a digital image of the fingerprint pattern. The captured image is typically referred to as a “live scan.” The live scan is digitally processed to create a biometric template, which is stored in a database. When identification verification is subsequently required, a new record is captured and compared with the records in the database. If the data in the new record matches that in the database record, the person's identity is confirmed. A variety of different sensors can be used to capture digital images of fingerprints. Indeed, fingerprint sensors may include, for example: (a) optical sensors which capture a digital image of a fingerprint using visible light; (b) ultrasonic sensors which use the principles of medical ultrasonography to create visual images of the fingerprint; and (c) capacitance sensors which use the principles associated with capacitance to form fingerprint images.

Matching algorithms are used to compare previously stored templates of fingerprints (live scans) against candidate fingerprints for authentication purposes. Pattern-based algorithms compare the basic fingerprint patterns between a previously stored live scan and a candidate fingerprint. The candidate fingerprint image is graphically compared with the template to determine the degree to which they match. If the data in the candidate fingerprint matches the template in the database record, the person's identity is confirmed. It is understood that an exact match is not required to confirm a person's identity. Indeed, substantial matches between the candidate fingerprint and the template (e.g. a 90% or greater match) may be sufficient to confirm a person's identity.

Facial recognition systems are physiological biometric systems which verify a person from a digital image or a video frame from a video source. Facial recognition systems use facial recognition algorithms to identify specific features from a person's face. For example, an algorithm may analyze the relative position, size, and/or shape of the person's eyes, nose, cheekbones, and jaw (facial geometry). 3-D sensors may be used to capture information about the shape of the face. Skin texture may be analyzed to compare unique lines, patterns, and spots apparent in one's skin. This information is then converted into a digital format to provide a mathematical representation of the individual's face (candidate), which is used to search for other images with matching characteristics (e.g. skin texture, shapes and features). If the data in the candidate matches a record in the database record, the person's identity is confirmed. It is understood that an exact match is not required to confirm a person's identity. Indeed, substantial matches between the candidate and a record in the database (e.g. a 90% or greater match) may be sufficient to confirm a person's identity.

Iris recognition is a method of physiological biometric authentication that uses pattern recognition techniques based on high-resolution images of the iris, which is the colored area that surrounds the pupil. Iris recognition systems use cameras to create images of the intricate concentric circular outer boundaries of the iris and the pupil in a photograph of the eye. When these images are converted into digital templates, they provide mathematical representations of the iris, which are compared against iris images stored in a database. In that iris patterns are unique, comparing a new record to iris structures in a database provides for the unambiguous positive identification of an individual.

Retina recognition is a method of physiological biometric authentication which captures and analyzes the patterns of blood vessels on the thin nerve on the back of the eyeball that processes light entering through the pupil. Retinal patterns are highly distinctive traits. Indeed, every eye has its own unique pattern of blood vessels, even in the case of identical twins. Moreover, a person's pattern of blood vessels typically remains fixed over one's lifetime, therefore making retina recognition a reliable way to identify an individual. Retinal recognition systems convert images of an individual's retinal patterns into digital templates, to provide mathematical representations of the pattern of blood vessels in the retina, which can be compared to retinal patterns stored in a database to yield unambiguous positive identification of an individual.

Hand geometry is a physiological biometric that identifies users by the shape of their hands. Hand geometry recognition systems measure the physical characteristics of a person's hand, including length, width, thickness, and surface area, for example, and compare those measurements to measurements stored in a database. Hand geometry is a reliable means for authentication when combined with other forms of authentication, including knowledge-based information systems.

Ear lobe geometry is a physiological biometric that identifies users by the shape of their ear lobes. Ear lobe geometry recognition systems measure the physical characteristics of a person's ear lobes, and compare those measurements to measurements stored in a database. Ear lobe geometry is a reliable means for authentication when combined with other forms of authentication, including knowledge-based information systems.

Speaker recognition is a type of behavioral biometric which validates a person's identity using characteristics from their voice, and is based on the premise that the acoustic features of speech differ between individuals. Indeed, one's acoustic patterns are a result of both anatomy and learned behaviors. Speaker recognition systems have an enrollment phase and a test phase. In the enrollment phase, the speaker's voice is recorded and a number of features are extracted to form a “voice print.” In the test phase, one's speech is compared against a voice print to determine if the person's voice matches the voice print. If the speech recorded by the individual matches the voice print in the database record, the person's identity is confirmed.

Signature recognition is a type of behavioral biometric which validates a person's identity using characteristics from their signature, and is based on the premise that handwriting characteristics differ between individuals. Indeed, one's handwriting characteristics are a result of both anatomy and learned behaviors. Signature recognition systems have an enrollment phase and a test phase. In the enrollment phase, a person's signature is recorded and analyzed based on a variety of features. In the test phase, the individual's signature is compared against the recorded signature(s) to determine if the person's signature matches the signature saved in the database. If the individual's signature matches a signature in the database record, the person's identity is confirmed.

Keystroke dynamics is a type of behavioral biometric which validates a person's identity using characteristics observed when an individual types on a keyboard, and is based on the premise that the manner in which individuals type on a keyboard differ between individuals. Indeed, the way one types on a keyboard is a result of both anatomy and learned behaviors. Systems which analyze and compare keystroke dynamics systems have an enrollment phase and a test phase. In the enrollment phase, an individual is given a keyboard and asked to type. The individual's keystrokes are recorded and analyzed based on a variety of features. In the test phase, the individual's keystroke dynamics are compared against recorded keystroke dynamics to determine if the person's keystroke dynamics match the keystroke dynamics saved in the database. If the individual's keystroke dynamics matches the keystroke dynamics in the database record, the person's identity is confirmed.

### SUMMARY OF THE INVENTION

One embodiment of the invention is a method for inhibiting movement of a movable portion of a folding partition. The method comprises receiving a request, at a control panel, to move a movable portion of a folding partition; transmitting a first electromagnetic wave from the control panel; receiving a second electromagnetic wave at the control panel; determining, by the control panel, that a tag is disposed in a vicinity of the control panel; and inhibiting, by the control panel, movement of the movable portion.

Another embodiment of the invention is a method for inhibiting movement of a movable portion of a folding partition. The method comprises receiving a request, at a control panel, to move a movable portion of a folding partition; moving the movable portion; transmitting a first electromagnetic wave from the control panel; receiving a second electromagnetic wave at the control panel; determining, by the control panel, that a tag is disposed in a vicinity of the control panel; and inhibiting, by the control panel, movement of the movable portion.

### BRIEF DESCRIPTION OF THE DRAWINGS

FIG. 1 is a system drawing of a system for enhancing the safety of electrically operated folding partitions in accordance with an embodiment of the invention.

FIG. 2 is a flow chart of a process which could be performed in accordance with an embodiment of the invention.

### DETAILED DESCRIPTION OF THE PREFERRED EMBODIMENT(S)

Each of the biometric verification systems described above record a person's unique biological traits, which are kept in a database during an enrollment phase, and then capture a new record when identification verification is required; the verification systems then compare the new record with the records in the database to estimate the distance between the new record and the stored templates using an algorithm. If the data in the new record matches that in the database record, the person's identity is confirmed.

Accordingly, each of the biometric verification systems described above function to verify the identity of an individual, based on the individual's unique biological traits. Each of the biometric verification systems described above may be coupled to an electrically operated folding partition system to verify the identity of the operator thereof before the electrically operated folding partition becomes operable. Each of the biometric verification systems described above may be coupled to an electrically operated folding partition system to verify the identity of the operator thereof while the electrically operated folding partition is in operation, such that the electrically operated folding partition will cease to operate if the biometric verification system is unable to verify the operator's biological information. In that the operator's physical presence is required (to provide biological data), the electrically operated folding partition will not operate, or will cease to operate, if the operator is not present.

Electrically operated folding partition systems may include an authentication system which verifies the identity of an individual based on knowledge-based information and biometric characteristics, such as a system that requires that operator of the electrically operated folding partition enter a personal identification number, for example, in addition to providing the required biological data. Accordingly, by providing an electrically operated folding partition system which includes an authentication system which verifies the identity of an individual based on both knowledge-based information biometric characteristics, two different factors are utilized to verify the identity of an individual, therefore increasing the security of the system.

The disclosure provides an electrically operated folding partition system that includes a mechanism to verify the identity of the operator(s) of the electrically operated folding partition. The electrically operated folding partition will be inoperable unless and until the verification mechanism can verify the identity of the operator(s) of the electrically operated folding partition. The electrically operated folding partition will cease to operate if the verification mechanism is unable to verify the identity of the operator(s) of the electrically operated folding partition. The electrically operated folding partition system verifies the identity of the operator(s) of the electrically operated folding partition using a biometric authentication mechanism to compare biometric characteristics. The electrically operated folding partition system includes an authentication system which verifies the identity of an individual based on both knowledge-based information and biometric characteristics.

In one embodiment of the present invention, the electrically operated folding partition system is controlled by a control panel, including an extend switch and a stack switch, relays and a motor. In a preferred embodiment, the electrically operated folding partition includes at least one control panel at each end of the electrically operated folding partition. Including at least one control panel on each side of the folding partition requires that a trained authorized operator, as identified by the authentication device, is present at each end of the electrically operated folding partition the entire time the electrically operated folding partition is being operated.

The system further includes an authentication device which authenticates the identity of an operator of the electrically operated folding partition coupled to the at least one control panel before the folding partition becomes operable.

The system may be used in conjunction with existing electrically operated folding partition systems which include, for example, a key switch, an extend switch, a stack switch, a control panel, control relays and a motor, yet lack an authentication device. For example, an interface having an authentication device may be coupled to the control panel of an existing electrically operated folding partition.

The electrical operation circuit of the folding partition may be restarted after the authentication device successfully authenticates the identity of the operator. The restarting may include a reset control key switch, which when turned on will reactivate the control panel.

The authentication device may include at least one biometric recognition system which compares at least one biometric characteristic. The biometric recognition system may be fingerprint recognition systems, facial recognition systems, earlobe recognition systems, hand geometry recognition systems, iris recognition systems, retina recognition systems, voice recognition systems, signature recognition systems, key stroke recognition systems, and combinations thereof.

The electrically operated folding partition may include an authentication system which verifies the identity of an individual based on both knowledge-based information and biometric characteristics. The system may verify the identity of an individual based on knowledge-based information including, for example passwords and codes, in addition to biometric characteristics, or other possession-based information.

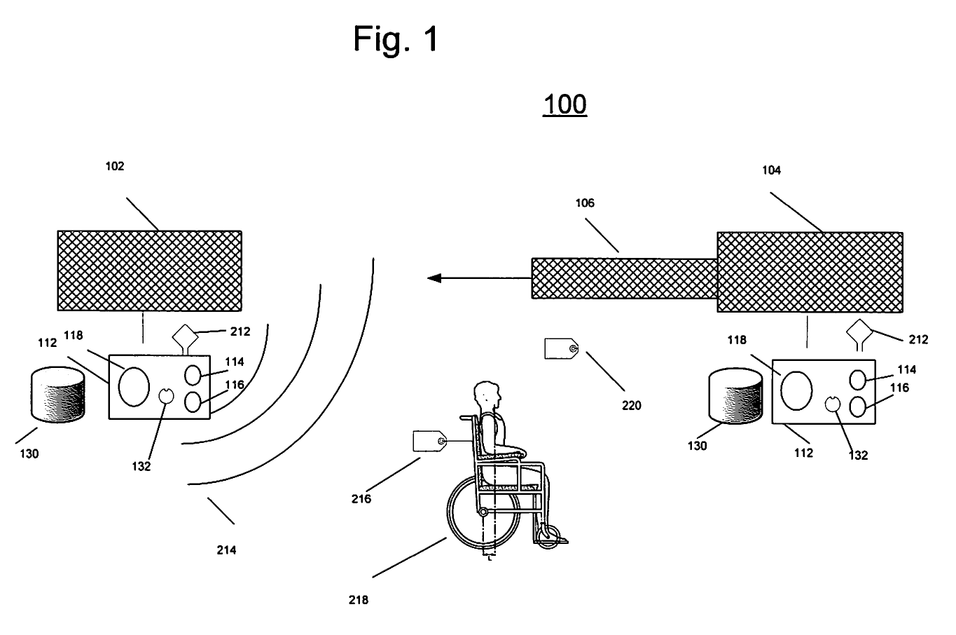

Referring to FIG. 1, the present disclosure includes a system 100 effective to electrically operate a folding partition. System 100 includes a folding partition comprising a first end 102, a second end 104 and a movable portion 106. A control panel 112 is used to control movement of moveable portion 106. Control panel 112 may include an extend switch 114, and a stack switch 116. Control panel 112 is used to control a motor (not explicitly shown) that moves moveable portion 106. Extend switch 114 and stack switch 116 may be replaced by a key switch having a first position and a second position, which is used to stack and extend moveable portion 106 of the folding partition.

An authenticating device 118 may be used in control panel 112 to authenticate an the identity of an operator of the partition. By including at least one authenticating device 118 at each end 102, 104 of the folding partition, the presence of at least two operators may be required.

If authentication device 118 fails to authenticate the identity of an operator, control panel 112 may inhibit movement of moveable portion 106. Moreover, if authentication device 118 fail(s) to authenticate the identity of the operator after movable portion 106 has started moving, the electrically operated folding partition will cease to operate. Thereafter, restarting switch may restart the motor of the folding partition after authentication device 118 successfully authenticates the identity of the operator.

Authentication device 118 may include a biometric recognition system. Biometric recognition systems identify individuals by evaluating one or more distinguishing biological traits. Unique identifiers include fingerprints, facial geometry, hand geometry, earlobe geometry, retina and iris patterns, voice waves, signatures, and keystroke dynamics. In general, biometric verification systems record a person's unique biological traits, which are kept in a database during an enrollment phase. When identification verification is subsequently required, a new record is captured and compared with the records in the database stored in the test phase to estimate the distance between the new record and the stored templates using an algorithm. If the data in the new record matches that in the database record, the person's identity is confirmed.

Authentication device 118 may be a fingerprint recognition system. To close moveable portion 106, an operator may first provide biometric information to authentication device 118. The operator may place his or her finger on authentication device 118, which captures an image of the individual's fingerprint and compares the image of the individual's fingerprint with fingerprint images in a database 130. If the image of the operator's fingerprint matches a fingerprint image in the database, the operator's identity is confirmed. Once the operator's identity is confirmed, the operator presses extend switch 114. Pressing extend switch 14 operates the motor to move moveable portion 106. Moveable portion 106 then moves along an operating path and extends to end 102.

To open electrically operated folding partition, an operator first provides biometric information to authentication device 118. The operator may place his or her finger on authentication device 118, which captures an image of the operator's fingerprint and compares the image of the operator's fingerprint with fingerprint images in database 130. If the image of the operator's fingerprint matches a fingerprint image in database 130, the operator's identity is confirmed. Once the operator's identity is confirmed, the operator presses stack switch 116. Pressing stack switch 16 causes operation of the motor to cause moving portion 106 to open along the operating path and stack up to end 104.

If authentication device 118 is unable to verify the identity of the operator at any time in which the electrically operated partition is in operation, control panel 112 will inhibit operation of the motor.

A key switch 132 may be included on control panel 112. An operator may first be requested to move key switch 132 to a first position and provide biometric information to authentication device 118. Once the operator's identity is confirmed, the operator may turn key switch 132 to a second position to operate the motor to close moving portion 106 and to a third position to open moving portion 106.

Authentication device 118 may verify the identity of an individual based on both knowledge-based information and biometric characteristics. For example, authentication device 118 may request that the operator of the electrically operated folding partition enter a personal identification number, for example, in addition to providing the biological data. Accordingly, by providing an electrically operated folding partition system which includes an authentication device 118 which verifies the identity of an individual based on knowledge-based information and biometric characteristics, two different factors are utilized to verify the identity of an individual, therefore increasing the security of the system.

As stated above, the present invention may be used in conjunction with existing electrically operated folding partition systems that lack an authentication device 118.

Control panel 112 may also include an RF-ID (radio frequency identification) reader 212. RF-ID reader 212 is effective to emit an electromagnetic wave 214 in an area proximate to a respective end 202, 204 (only one wave 214 for end 102 is shown). RF-ID tags 216, 220 may be placed on objects used by, for example, disabled individuals such as on a wheelchair 218, crutches, cane, etc. An RF-ID tag 216 or 220 may be worn by an individual. When electromagnetic wave 214 is incident upon tags 216, 220, tags 216, 220 affect a reflection of electromagnetic wave 214 back to RF-ID reader 212. Such an affect on the reflection of electromagnetic wave 214 is detected by RF-ID reader 212 and may effectively communicate some information to RF-ID reader 212 such as an identification number. The identification number is compared with numbers stored in database 130. If the identification number received by RF-ID reader 212 matches numbers stored in database 130, indicating that tag 216, 220 is part of system 100, control panel 112 may then use this information to control movement of moveable portion 106.

For example, when an operator first desires to move moveable portion 106, RF-ID reader 212 may generate electromagnetic wave 214 to determine whether any tag 216, 220 and consequently a disabled individual, is in a vicinity of first and second ends 202, 204. If tags 216, 220 are in the vicinity of ends 202, 204, as detected by RF-ID reader 212, control panel 112 may inhibit movement of moveable portion 106. Otherwise, moveable portion 106 may be moved or authentication may be performed as discussed before. After control panel 112 initiates movement of moveable portion 106, control panel 112 may continually transmit electromagnetic wave 214 while moveable portion 106 is moving to continually check whether tags 216, 220, and perhaps a disabled individual, are in a vicinity of ends 202, 204. If tags 216, 220 are detected while moveable portion 106 is moving, control panel 112 may control moveable portion 106 to stop moving.

Another embodiment can include the use of an RF-ID system at one of the first end or the second end. In such an embodiment one RF-ID reader 212 may generate electromagnetic wave 214 strong enough to reach and to determine whether any tag 216, 220 and consequently a disabled individual, is in a vicinity of first and second ends 202, 204. If tags 216, 220 are in the vicinity of ends 202, 204, as detected by RF-ID reader 212, control panel 112 may inhibit movement of moveable portion 106.

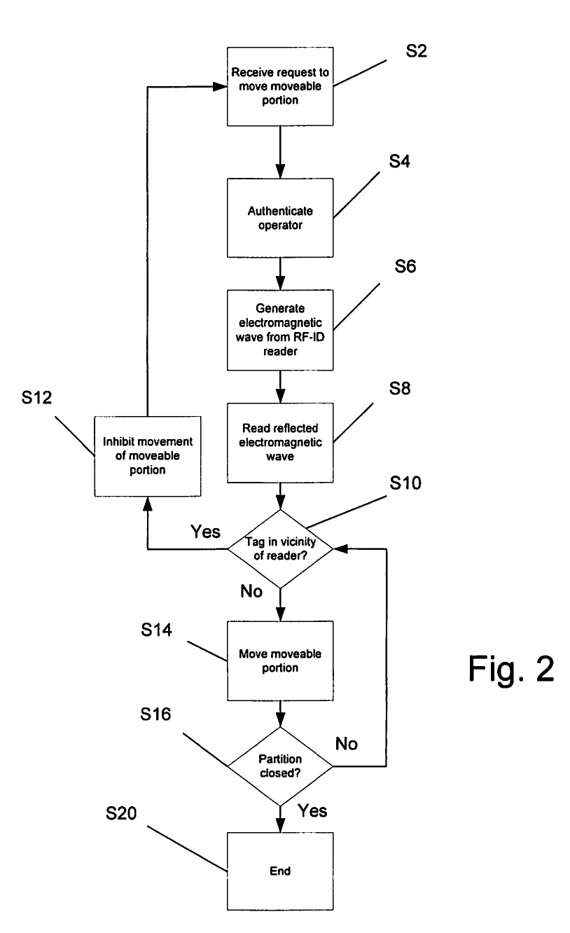

Referring to FIG. 2, there is shown a process which could be performed in accordance with an embodiment of the invention. The process could be performed using, for example, system 100 discussed above. As shown, at step S2, a control panel may receive a request to move a moveable portion of a folding partition. At step S4, the control panel may authenticate the operator such as by, for example, through a biometric authentication. At step S6, the control panel may generate an electromagnetic wave from an RF-ID reader. At step S8, the control panel may read waves reflected back to the control panel. If a tag is in the vicinity of the RF-ID reader, the reflection of the electromagnetic wave may have been altered to include certain information. At step S10, the control panel queries whether a tag is in the vicinity of the RF-ID reader. If the answer to query S10 is yes, control branches to step S12 where the control panel inhibits movement of the moveable portion and control branches back to step S2 where the control panel awaits another request to move the moveable portion.

If the answer to query S10 is no, control branches to step S14 where the moveable portion is moved. A query is then made at step S16 to determine whether the partition is closed. If the answer is yes, control ends at step S20. If the answer to query S16 is no, control branches to step S10. In this way, while the moveable portion is closing, the control panel continually monitors whether a tag is in a vicinity of the reader.

While the invention has been described with reference to a number of exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to any particular exemplary embodiment disclosed herein.

What is claimed is:

1. A method for inhibiting movement of a movable portion of a folding partition, the method comprising:
receiving, at a control panel, a request to move a movable portion of a folding partition;
transmitting a first electromagnetic wave from the control panel;
receiving a second electromagnetic wave at the control panel;
determining, by the control panel, that a tag is disposed in a vicinity of the control panel; and
inhibiting, by the control panel, movement of the movable portion.

2. The method of claim 1, further comprising:
receiving, at the control panel, identification of an operator of the control panel;
determining, by the control panel, that the operator of the control panel is not authorized to operate the control panel; and
inhibiting, by the control panel, movement of the movable portion.

3. The method of claim 2, wherein the identification of the operator of the control panel is at least one of possession-based information and knowledge-based information.

4. The method of claim 3, wherein the possession-based information includes at least one of a password, an identification card, and a key.

5. The method of claim 3, wherein the knowledge-based information includes at least one of fingerprints, facial geometry, hand geometry, earlobe geometry, retina patterns, iris patterns, voice waves, signatures, and keystroke dynamics.

6. The method of claim 1, wherein the tag is a radio frequency identification (RF-ID) tag.

7. The method of claim 6, wherein the second electromagnetic wave is generated by the RF-ID tag when the first electromagnetic wave is incident upon the RF-ID tag.

8. The method of claim 1, wherein the tag is at least one of affixed to an object used by an individual and worn by an individual.

9. The method of claim 1, wherein the control panel determines if at least one of a plurality of tags is disposed in a vicinity of the control panel.

10. A method for inhibiting movement of a movable portion of a folding partition, the method comprising:
receiving, at a control panel, a request to move a movable portion of a folding partition;
moving the movable portion;
transmitting a first electromagnetic wave from the control panel;
receiving a second electromagnetic wave at the control panel;
determining, by the control panel, that a tag is disposed in a vicinity of the control panel; and
inhibiting, by the control panel, movement of the movable portion.

11. The method of claim 10, further comprising:
receiving, at the control panel, identification of an operator of the control panel;
determining, by the control panel, that the operator of the control panel is not authorized to operate the control panel; and
inhibiting, by the control panel, movement of the movable portion.

12. The method of claim 11, wherein the identification of the operator of the control panel is at least one of possession-based information and knowledge-based information.

13. The method of claim 12, wherein the possession-based information includes at least one of a password, an identification card, and a key.

14. The method of claim 12, wherein the knowledge-based information includes at least one of fingerprints, facial geometry, hand geometry, earlobe geometry, retina patterns, iris patterns, voice waves, signatures, and keystroke dynamics.

15. The method of claim 10, wherein the tag is a radio frequency identification (RF-ID) tag.

16. The method of claim 15, wherein the second electromagnetic wave is generated by the RF-ID tag when the first electromagnetic wave is incident upon the RF-ID tag.

17. The method of claim 10, wherein the tag is at least one of affixed to an object used by an individual and worn by an individual.

18. The method of claim 10, wherein the control panel determines if at least one of a plurality of tags is disposed in a vicinity of the control panel.

19. A system for inhibiting movement of a movable portion of a folding partition, the system comprising:
a control panel for receiving a request to move a movable portion of a folding partition, transmitting a first electromagnetic wave from the control panel, receiving a second electromagnetic wave, determining that a tag is disposed in a vicinity of the control panel, and inhibiting movement of the movable portion; and
the tag for receiving the first electromagnetic wave and transmitting the second electromagnetic wave when the first electromagnetic wave is received.

20. The system of claim 19, further comprising:
an operator authentication system included in the control panel for identifying a user of the control panel and an authorized user of the control panel,
wherein the control panel determines that the operator of the control panel is not authorized to operate the control panel and inhibits movement of the moveable portion when the control panel determines that the operator of the control panel is not authorized to operate the control panel.
